(19) United States
(12) Patent Application Publication
(10) Pub. No.: US 2024/0102533 A1
(43) Pub. Date: Mar. 28, 2024

(54) TOOTHED BELT DRIVE WITH VARYING TOOTH PITCH

(71) Applicant: ContiTech Antriebssysteme GmbH, Hannover (DE)

(72) Inventors: Thomas Melz, Hannover (DE); Heiko Sattler, Wedemark (DE)

(73) Assignee: ContiTech Antriebssysteme GmbH, Hannover, OT (DE)

(21) Appl. No.: 17/754,646

(22) PCT Filed: Sep. 3, 2020
(86) PCT No.: PCT/EP2020/074569

§ 371 Date: Apr. 7, 2022

(30) Foreign Application Priority Data
Oct. 17, 2019 (DE) 10 2019 215 965.6

(51) Int. Cl. F16G 1/28; F16H 55/17; F16H 55/18

(52) U.S. Cl. CPC F16G 1/28; F16H 55/171; F16H 55/18

(57) ABSTRACT

Toothed belt drive with a toothed belt and at least two toothed pulleys, wherein the toothed belt has at least one drive side provided with a toothed profile, the toothed belt wraps around the toothed pulleys over a partial area of their circumference and the teeth of the toothed belt meshingly engage in the tooth gaps of the toothed pulleys, wherein at least one of the toothings on the belt or pulley is formed as a series of tooth pitches varying along the circumference, wherein
the individual tooth pitches are designed to vary by up to a maximum of 5% relative to the mean tooth pitch on the belt or pulley, and
the absolute deviation of a varied tooth pitch from the mean tooth pitch on the belt or pulley is limited by the backlash of the toothing,
   wherein the backlash E_{S} results from the difference of the width e_{S} of the tooth gaps of the respective toothed pulley and the width e_{R} of the teeth of the toothed belt in the middle of the tooth height of the teeth of the toothed belt.

The invention relates to a toothed belt drive with a toothed belt and at least two toothed pulleys, wherein the toothed belt has at least one drive side provided with a toothed profile, the toothed belt wraps around the toothed pulleys over a partial area of their circumference and the teeth of the toothed belt meshingly engage in the tooth gaps of the toothed pulleys.

One of the challenges when designing such toothed belt drives is in providing toothed belt drives that run as silently as possible and in reducing as far as possible the generation of noise. Running noises result in particular from the constructive and geometric conditions in the engagement of the teeth in the toothed belt pulley and from the resulting vibrations and oscillations in the strand. Even though a reduction in noise is already possible by changing from spur-geared toothed belt drives to helically-geared toothed belt drives, the noise emissions still present in the latter are also significant and undesirable.

According to the current state of the art, toothed belts are manufactured on vulcanization molds that have a tooth pitch that is as precise and uniform as possible over their circumference and which then also transfer this to the belt blanks to be vulcanized. Due to this constant, regular pitch, there occurs significant noise development during operation when the belt meshes with the equally regularly manufactured toothed pulleys, triggered substantially by a vibration in the tooth meshing frequency, the sound power level of which is audible and measurable. The energy of this vibration is radiated directly as airborne noise or transmitted as structure-borne noise and radiated indirectly elsewhere.

In order to achieve a low level in the tooth meshing frequency, it is known in the prior art, for example, to form groups of differently designed pitches and to arrange these “pitch groups” over the length or circumference of the belt in such a way that a uniform tooth meshing frequency cannot be built up or that destructive interference results. With such a so-called “low-noise toothing”, the individual groups can differ in the pitch by up to 20%. Of course, the pitch of the toothed pulleys in the form of groups must also be adjusted accordingly. This also creates a major disadvantage of this type of toothing. This is due to the fact that there has to occur an absolutely precise and adapted mounting of the belt drive with pitch groups that correspond exactly to one another on the toothed pulley and on the toothed belt, which of course makes installation more difficult and very error-prone. There must always be a multiple of a group of teeth that match one another on the belt and toothed pulley and the belt must be fitted accordingly. A further disadvantage arises from the fact that if the belt skips, for example in the event of an overload, the belt is immediately destroyed if different pitch groups necessarily have to engage with one another.

On the other hand, there are proposals in the prior art to reduce the noise development by changing the backlash. EP 1 614 933 B1 discloses in this respect a helically-geared belt drive in which noise and vibration are to be reduced in that the play, that is to say the backlash (“D”), between the helically-geared belt and a toothed pulley is set in a specified ratio to the tooth pitch at a specific tooth pitch angle and predetermined width of the toothed belt. EP 2 803 879 A1 proposes similar measures, in particular for the reduction in noise in the case of toothed belt drives in electrical power steering assemblies. Here, too, the gap clearance, the backlash, is adjusted depending on the tooth width and tooth height.

The design of the profile of toothed pulleys as the counterpart of toothed belts and the profile of the latter in helically-geared toothed belt drives thus always envisages a certain degree of play, that is to say a certain degree of “backlash”, not least in order to guarantee a certain capability of the belt to be displaced in relation to the toothed pulley in the circumferential direction and thus in order to compensate for production tolerances of the belt and for variable tensile forces and for dissimilar pitch lengths resulting from the latter in the wrapped arc. It is the superordinate objective herein for the play to be configured such that an unimpeded run-in of the toothed belt into both toothed pulleys is achieved in order for the generation of airborne noise and structure-borne noise to be minimized.

However, the measures known in the prior art for reducing the airborne noise and structure-borne noise in the case of toothed belt drives are no longer adequate in the case of an interaction between comparatively large and small toothed pulleys, in particular thus in toothed belt drives for comparatively large gear ratios. In the case of toothed belt drives in particular, which have step-up ratios/step-down ratios and for instance reduce the speed from input to output, the measures mentioned are already not sufficient because the meshing conditions when running into a small toothed pulley/pinion differ significantly from those when running into a larger toothed pulley.

The object of the invention was therefore to provide a belt drive that runs as quietly and with as little impact as possible when engaged, generates few vibrations and oscillations in the strand even at high speeds, does not require any pitch groups and can be easily assembled and installed regardless of the running direction and circumferential position.

This object is achieved by the features of the main claim. Further advantageous embodiments are disclosed in the dependent claims.

At least one of the toothings on the belt or pulley is designed with a series of varying tooth pitches, wherein
the tooth pitches of the belt or pulley along the circumferential direction are designed to vary by up to a maximum of 5% relative to the respective mean tooth pitch, such as the nominal pitch at the height of the effective cord line determined by the cord center, the mesh pitch at the height of the pulley tip circle and the pitch at mean tooth height, and
the absolute deviation of these varying tooth pitches from the mean tooth pitch on the belt or pulley is limited by the absolute backlash, wherein the backlash is defined as the difference of the width of a tooth gap of the pulley and the width of the engaging belt tooth at the center of the tooth height.

The nominal pitch P of the toothed belt and toothed pulley is the pitch at the height of the effective cord line, that is to say on the radius or arc defined by the center of the cord (cord center) of the toothed belt wrapped around the toothed pulley. The nominal pitch line or the nominal pitch arc is therefore radially outside the teeth of the toothed pulley, that is to say outside the tooth tip circle of the toothed pulley.

The variation according to the invention of the tooth pitches considerably reduces structure-borne noise and strand vibrations and thus the sound power level, by spectrally precalculating the series of tooth meshing with different deviations from the nominal pitch on the superimposition of their impulses when the belt runs into a toothed pulley and selecting the (best) sequence for production on the belt or the toothed pulley in which the level of the tooth meshing order is minimized, with the constraint that the levels of the secondary orders do not exceed the tooth meshing order.

The permissible backlash limits the variation of the tooth pitch according to the invention in principle as an upper limit, the backlash being defined as the free space between the belt tooth and two adjacent toothed pulley teeth along the engagement arc at half the tooth height of the belt. The design of the toothed belt drive according to the invention means that a considerable reduction in the sound power level of the usually monotonous, strongly dominant tooth meshing frequency can be achieved.

An advantageous development of the invention is that the changing tooth pitch on the belt or pulley is formed periodically or according to a predetermined pattern. With such a design, one approaches the basic idea of the low-noise toothing known in the prior art, but without having to accept the existing disadvantage which arise from the formation of pitch groups. The periodic tooth pitch, or one that varies according to a predetermined pattern, leads to further suppression of noise generation or to destructive interference with nevertheless occurring vibrations.

A further advantageous embodiment of the invention is that the varying tooth pitch on the belt or pulley is formed in the positive or negative direction, that is to say leads to an increased and/or reduced pitch with regard to the mean pitch. Both types of variation can significantly lower the sound power level.

A further advantageous embodiment of the invention is that the toothed belt or the toothed pulley is designed with a varying tooth pitch and the respective other part is designed with a regular tooth pitch. This expands the possibilities for reducing noise generation and can be further increased by the fact that, in the context of a further advantageous embodiment, the toothed belt and the toothed pulley are designed with a varying tooth pitch. Depending on the application, the belt drive can thus be precisely adapted to the required noise reduction. This is particularly important when such a toothed belt drive is used in electric power steering gears in motor vehicles, in particular designed with helical toothing.

A further advantageous embodiment of the invention consists in the fact that the series of varying tooth pitches is selected in such a way that the lowest possible level in the tooth meshing order results.

A further advantageous embodiment of the invention consists in the fact that the levels of the orders adjacent to the tooth meshing order do not exceed this.

The invention will be explained in more detail on the basis of an exemplary embodiment. In the figures:

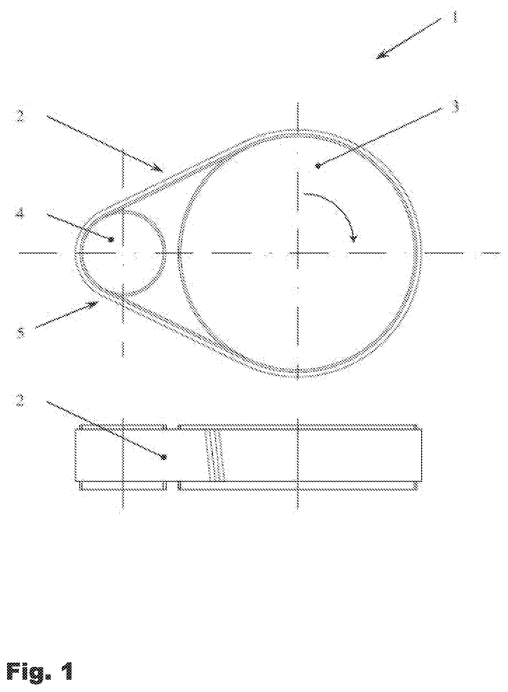

FIG. 1 shows a basic representation of the belt drive according to the invention,

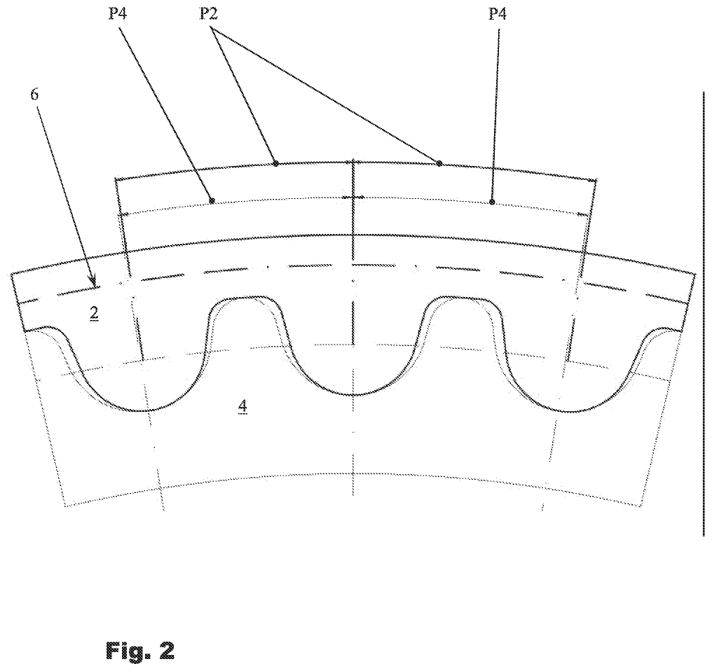

FIG. 2 shows the meshing conditions between the toothed belt and toothed pulley with a pitch variation on the toothed belt in an enlarged view,

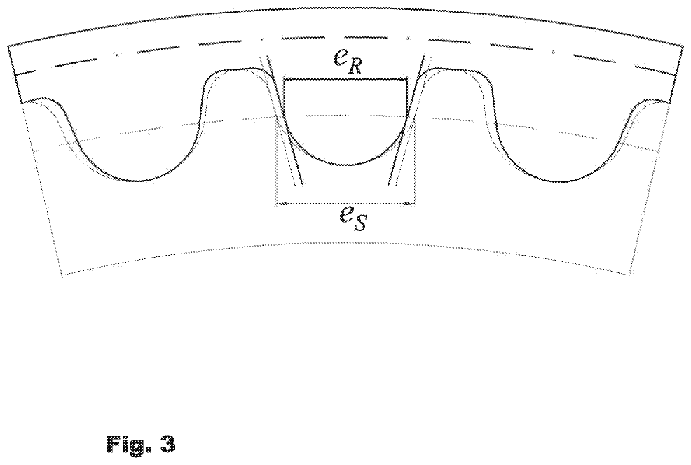

FIG. 3 shows the backlash as play or the difference in the gap between two adjacent toothed pulley teeth and a belt tooth at half the tooth height of the belt in an enlarged view,

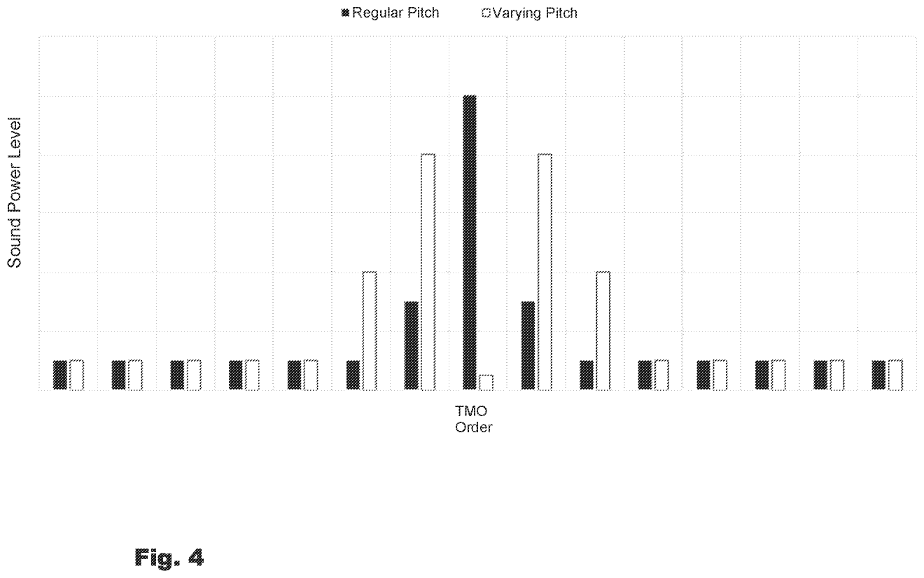

FIG. 4 shows a diagram with a spectral comparison of sound power levels in the tooth meshing order (TMO) and secondary orders with reduction of the level of the tooth meshing order by a series of varying pitches compared with a regular pitch,

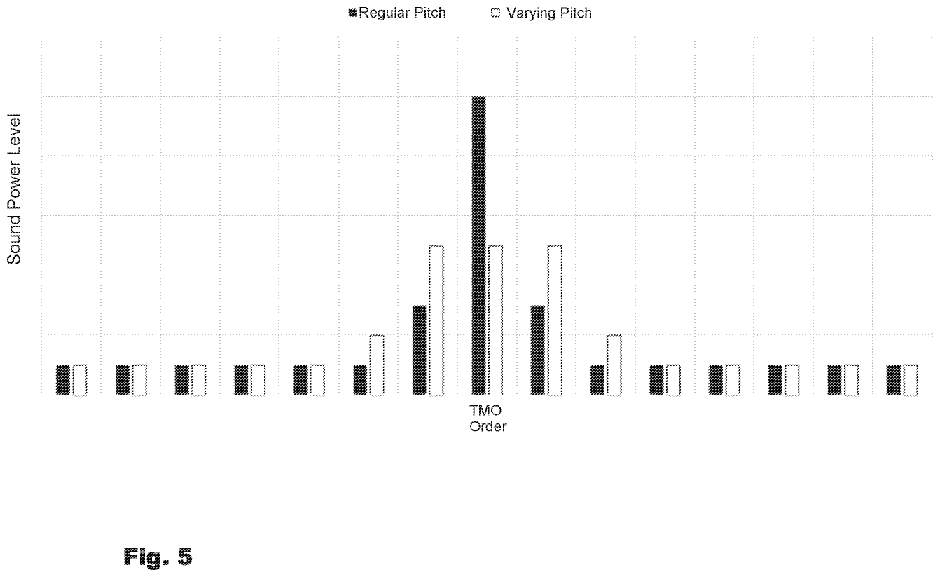

FIG. 5 shows a diagram with spectral comparison of sound power levels in the tooth meshing order (TMO) and secondary orders with reduction of the level of the tooth meshing order and limitation of the secondary order level to the level of the tooth meshing order by another, improved series of varied pitches compared with a regular pitch.

FIG. 1 shows a helically-geared toothed belt drive 1 with a toothed belt 2, a large toothed pulley 3 as the driven pulley and a small toothed pulley 4 as the drive pulley. The toothed belt 2, by way of the drive side thereof that is provided with a toothed profile, runs onto the small toothed pulley 4 in the run-in region 5. The small toothed pulley 4 has a toothed profile that is complementary to the toothed profile of the belt, wherein the toothed belt wraps around the toothed pulleys over a partial area of their circumference, and the teeth of the toothed belt meshingly engage in the tooth gaps of the toothed pulleys. The same correspondingly applies to the large toothed pulley 3.

FIG. 2 shows the meshing conditions between the toothed belt 2 (solid line) and toothed pulley 4 (thin line) in the embodiment according to the invention as claimed in claim 1 in an enlarged view, with the toothed pulley 4 being configured with a regular pitch P4, while the toothed belt 2 is configured with a varying pitch P2. Shown are the regular pitch angle on the toothed pulley 4 corresponding to the nominal pitch P on the cord center 6 and two pitch angles on the toothed belt 2 that vary in comparison. For the sake of better clarity, the nominal pitch P on the cord center is not shown in this figure. At each radial level, whether at the cord center, the tip circle of the toothed pulley or the middle of the tooth height, the respective meshing pitches (or arc lengths) of the toothed pulley 4 and toothed belt 2 are thus different from one another.

FIG. 3 shows the absolute backlash, also referred to as play. This is the difference of the width of a tooth gap eS of the pulley 4 and the width of the meshing belt tooth eR in the middle of the tooth height.

If the noise of a toothed drive is subjected to an order analysis, the energy content of the noise is considered via an “order”, in the case of toothed belt drives via an order that is formed from a frequency spectrum that is calculated using a Fast Fourier Transform (FFT). An order spectrum can be mapped with an FFT, from which the level or the amplitude of each order can be determined with certain concurrent calculations/filters. This occurs with the frequency of the meshing engagement, the tooth meshing order, as well as with a number of secondary orders. This gives the diagrams shown in FIGS. 4 and 5, which show the amplitude of the sound power level of a belt drive with toothed pulley and toothed belt in spectral orders.

FIG. 4 shows a diagram which shows the amplitude of the sound power level of a belt drive with regular pitches on the toothed pulley and toothed belt from the prior art compared with a belt drive according to the invention in spectral orders. Here, the level of the tooth meshing order (TMO) is reduced to a fraction by a series according to the invention of varying pitches on the toothed belt, although the levels of a plurality of secondary orders exceed the level of the tooth meshing order (IMO).

FIG. 5 shows a diagram which in turn shows the amplitude of the sound power level of a belt drive with regular pitches on the toothed pulley and toothed belt from the prior art compared with a belt drive according to the invention in spectral orders. Here, although the level of the tooth meshing order (TMO) is reduced by another series according to the invention of varying pitches on the toothed belt, the levels of all secondary orders do not exceed that of the tooth meshing order (IMO).

### LIST OF REFERENCE SIGNS

### Part of the Description

1 Toothed belt drive
2 Toothed belt
3 Toothed pulley (driven pulley)
4 Toothed pulley (drive pulley)
5 Run-in region
6 Cord center
e_{S} Width of a tooth gap
e_{R} Width of the meshing belt tooth in the middle of the tooth height
P Nominal pitch
P2 Varying pitch of the toothed belt 2
P4 Regular pitch of the toothed pulley 4

1.-9. (canceled)

10. A toothed belt drive comprising a toothed belt and at least two toothed pulleys, wherein the toothed belt has at least one drive side provided with a toothed profile, wherein the toothed belt wraps around the toothed pulleys over a partial area of their circumference and teeth of the toothed belt meshingly engage in tooth gaps of the at least two toothed pulleys;
wherein at least one of toothings on the toothed belt or at least one pulley of the at least two toothed pulleys is formed as a series of tooth pitches varying along the circumference;
wherein individual tooth pitches are designed to vary by up to a maximum of 5% relative to a mean tooth pitch on the toothed belt or the at least one pulley of the at least two toothed pulleys, and wherein an absolute deviation of a varying tooth pitch from the mean tooth pitch on the is limited by backlash of the toothing; and,
wherein the backlash results from the difference of the width eS of the tooth gaps of the respective toothed pulley and width eR of teeth of the toothed belt in the middle of a tooth height of the teeth of the toothed belt.

11. The toothed belt drive as claimed in claim 10, in which the varying tooth pitch on the toothed belt or the at least one pulley of the at least two toothed pulleys is formed periodically or according to a predetermined pattern.

12. The toothed belt drive as claimed in claim 10, wherein the varying tooth pitch on the toothed belt or the at least one pulley of the at least two toothed pulleys is formed in a positive or a negative direction relative to the mean pitch.

13. The toothed belt drive as claimed in claim 10, wherein the toothed belt or the at least one pulley of the at least two toothed pulleys is designed with a varying tooth pitch and the respective other part is designed with a regular tooth pitch.

14. The toothed belt drive as claimed in claim 10, wherein the toothed belt and the at least one pulley of the at least two toothed pulleys are designed with a varying tooth pitch.

15. The toothed belt drive as claimed in claim 10, wherein the varying pitch is arranged in such a way that a lowest possible level in tooth meshing order (TMO) results.

16. The toothed belt drive as claimed in claim 15, wherein levels of orders adjacent to the tooth meshing order (TMO) resulting from the specific arrangement of the varying tooth pitches do not exceed the a lowest possible level in tooth meshing order (TMO).

17. An electric power steering gear for a motor vehicle comprising the toothed belt drive as claimed in claim 13.

18. A mold for producing a toothed belt for the toothed belt drive as claimed in claim 13, wherein the mold is designed in such way that the toothing of the mold that forms the belt teeth is formed with a series of varying tooth pitches which, in the belt circumferential direction formed in longitudinal or subsequent operation, are designed to vary by up to a maximum of 5% relative to a mean tooth pitch of the belt (nominal pitch) at the height of the effective cord line running through a cord center, a mesh pitch that results in subsequent operation at the height of a pulley tip circle, and a pitch at mean tooth height, wherein an absolute deviation of these varying tooth pitches is limited by absolute backlash, wherein the absolute backlash is defined as a difference of width, resulting in subsequent operation, of a tooth gap of the pulley and the width of the engaging belt tooth in the middle of the tooth height.
